(19) United States
(12) Patent Application Publication
(10) Pub. No.: US 2015/0379682 A1
(43) Pub. Date: Dec. 31, 2015

(54) VERTEX ATTRIBUTE DATA COMPRESSION WITH RANDOM ACCESS USING HARDWARE

(71) Applicant: Samsung Electronics Co., Ltd., Gyeonggi-do (KR)

(72) Inventors: Abhinav Golas, Mountain View, CA (US); Karthik W. Ramani, San Jose, CA (US); John W. Brothers, Calistoga, CA (US)

(21) Appl. No.: 14/715,172

(22) Filed: May 18, 2015

Related U.S. Application Data
(60) Provisional application No. 62/018,146, filed on Jun. 27, 2014.

(51) Int. Cl. G06T 1/60; G06T 15/00; G06T 1/20

(52) U.S. Cl. CPC G06T 1/60; G06T 1/20; G06T 15/005

(57) ABSTRACT

Processing vertex attribute data may include selecting a plurality of vertices of vertex attribute data and forming groups of components of the plurality of vertices according to component type. Packets of an encoded type or a generic type may be formed on a per group basis according to a data type of the components of each respective group.

### CROSS-REFERENCE TO RELATED APPLICATIONS

This application claims the benefit of U.S. Provisional Patent Application No. 62/018,146 filed on Jun. 27, 2014, which is fully incorporated herein by reference.

### TECHNICAL FIELD

This disclosure relates to processing geometric graphics data and, more particularly, to processing vertex attribute data.

### BACKGROUND

Within most modern graphics systems, images are represented by a plurality of polygons. The polygons are generally defined by geometric data. The geometric data may include two different data sets. The first data set, which may be referred to as vertex attribute data, specifies vertices for the polygons. The vertex attribute data may also include additional data items for the polygons. The second data set may include connectivity information for the vertices. The connectivity information specifies which vertices form the different polygons for a given object. In illustration, an object such as a ball may be represented using a plurality of polygons referred to as a mesh. To create a visual effect such as motion, features such as shape, location, orientation, texture, color, brightness, etc. of the polygons forming the ball are modified over time.

In generating visual effects, geometric graphics data may be operated upon by a graphics processing unit (GPU) multiple times. Consider an example where an object such as a ball moves through space. The polygons forming the ball may be continually operated upon by the GPU to produce a motion effect for the ball. Among other operations, for example, the coordinates of the vertices of the polygons forming the ball may be continually modified to produce the motion effect. Accordingly, the geometric graphics data flows through the graphics pipeline of the GPU multiple times in order to support such processing. A graphics pipeline refers to the processing or sequence of steps performed by a GPU to render a two-dimensional raster representation of a three dimensional scene.

For the GPU to process the graphics data, the graphics data is moved from memory through the graphics pipeline of the GPU as described. The geometric graphics data, including the vertex attribute data for the polygons, consumes a significant amount of the bandwidth. Given the demand for high quality graphics across various applications including games, the already high bandwidth requirements of graphics applications are likely to increase.

### SUMMARY

A method may include selecting a plurality of vertices of vertex attribute data and forming groups of components of the plurality of vertices according to component type. The method may also include forming packets of an encoded type or a generic type on a per group basis according to a data type of the components of each respective group.

A method may include determining a block, a packet within the block, and a local offset into the packet from a first address specifying requested vertex attribute data. The method may also include fetching the block from a memory, wherein the block includes the packet, and decompressing the block. The method further may include determining whether the packet is encoded and selectively decoding the packet according to the determination. At least a portion of the packet indicated by the local offset may be provided.

A system may include a write circuit configured to form groups of components of the plurality of vertices according to component type. The write circuit may form packets of an encoded type or a generic type on a per group basis according to a data type of the components of each respective group.

In another aspect, the system may include a read circuit configured to fetch the compressed block from memory, decompress the compressed block fetched from the memory, and selectively decode a packet of the block according to whether the packet is encoded.

This Summary section is provided merely to introduce certain concepts and not to identify any key or essential features of the claimed subject matter. Many other features and embodiments of the invention will be apparent from the accompanying drawings and from the following detailed description.

### BRIEF DESCRIPTION OF THE DRAWINGS

The accompanying drawings show one or more embodiments; however, the accompanying drawings should not be taken to limit the invention to only the embodiments shown. Various aspects and advantages will become apparent upon review of the following detailed description and upon reference to the drawings in which:

FIG. 1 is a block diagram illustrating an exemplary system;

FIG. 2 is a block diagram illustrating an exemplary implementation of a write circuit illustrated in FIG. 1;

FIG. 3 is a block diagram illustrating an exemplary implementation of a read circuit illustrated in FIG. 1;

FIG. 4 is a flow chart illustrating an exemplary method of writing geometric graphics data;

FIG. 5 is a flow chart illustrating an exemplary method of encoding packets; and

FIG. 6 is a flow chart illustrating an exemplary method of reading geometric graphics data.

### DETAILED DESCRIPTION

While the disclosure concludes with claims defining novel features, it is believed that the various features described herein will be better understood from a consideration of the description in conjunction with the drawings. The process(es), machine(s) and/or system(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to processing geometric graphics data and, more particularly, to processing vertex attribute data. In accordance with the inventive arrangements disclosed herein, vertex attribute data may be compressed. Vertex attribute data may be compressed and stored in a memory for subsequent retrieval in compressed form. When needed by a processor, the compressed vertex attribute data may be retrieved from the memory, decompressed, and made available to the processor. The compression and decompression of the vertex attribute data may be handled seamlessly so that the requesting system, e.g., processor, is unaware that the vertex attribute data is compressed prior to storage in memory and/or decompressed when fetched from memory.

The compression and decompression operations may be performed using hardware. As such, the vertex attribute data may be compressed and decompressed, as needed, rapidly. Despite storing the vertex attribute data using compression, a system requesting the vertex attribute data still may randomly access various portions of the vertex attribute data with little, if any, effect upon caching efficiency. Storing the vertex attribute data in compressed form requires less memory and less bandwidth to move the vertex attribute data between memory and the system utilizing the vertex attribute data.

In one aspect, the inventive arrangements described herein may be implemented as one or more processes, e.g., method(s). The method(s) may be performed by an apparatus, e.g., a system. In another aspect, the inventive arrangements may be implemented as an apparatus, e.g., a system, configured for processing geometric graphics data. For example, the apparatus may be implemented as one or more circuit blocks, as an integrated circuit (IC), as part of a processor such as a central processing unit (CPU) and/or a graphics processing unit (GPU), or the like. The system may operate in cooperation with, or be included as part of, a data processing system, a processor (e.g., a CPU and/or a GPU), a gaming system, entertainment and/or gaming console or appliance, a handheld device, a mobile phone, or other system that uses geometric graphics data.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

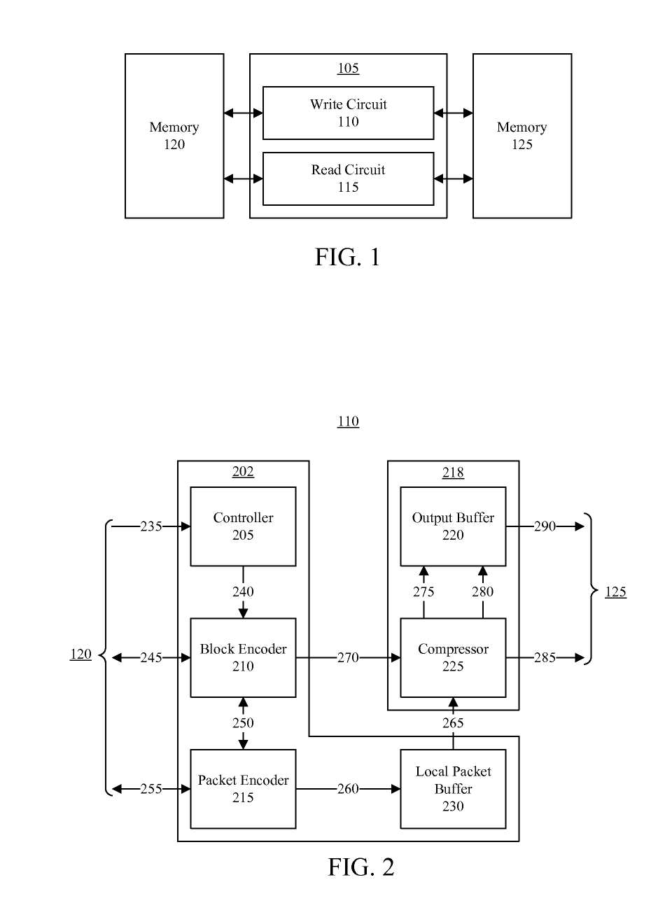

FIG. 1 is a block diagram illustrating an exemplary system 105. As pictured, system 105 is coupled to a memory 120 and a memory 125. In the example of FIG. 1, system 105 includes a write circuit 110 and a read circuit 115.

Graphics systems often operate upon one or more polygons at a time. The vertex attribute data is often clustered and bounded thereby exhibiting redundancy. System 105 is configured to perform operations involving geometric graphics data. In one particular example, system 105 is configured to perform operations upon vertex attribute data.

Vertex attribute data may include one or more vectors. Each vector may be referred to as an attribute. Each vector may include, or be formed of, a number of scalar components. Typically, the number of scalar components of a vector is limited to 4, though the inventive arrangements described within this disclosure are not limited by the number of scalar components included in a vector. Further, a vector may include fewer than 4 scalar components.

Examples of vectors, e.g., attributes, may include or specify, position, color, texture, or the like. In the case of a position attribute, for example, the attribute may be formed of three scalar components. The scalar components may be an x-coordinate, a y-coordinate, and a z-coordinate. In the case of a color attribute, for example, the scalar components may be a red value, a green value, and a blue value (RGB values). Each different scalar component in a vector may be considered a different type of scalar component. Thus, x-coordinates may be one type of scalar component, y-coordinates another, and z-coordinates yet another. In the case of color attributes, the red values may be one type of scalar component, the green values another, and the blue values yet another.

Within this disclosure, the term “component” refers to an individual item of a vector of vertex attribute data. Each component is a scalar value. Components may be specified using any of a variety of different data types. The term “data type” is a classification identifying one of various types of data. Exemplary data types of components may include, but are not limited to, floating point, fixed point, integer, Boolean, character strings, and/or the like. Further examples may include one or more or other data types of particular bit widths or precisions. Within modern graphics systems, components of a same component type are typically specified using a same data type. Thus, x-coordinates are usually specified using a same data type. Y-coordinates are usually specified using a same data type, etc.

In general, write circuit 110 may receive vertex attribute data. The vertex attribute data may be received from memory 120 or another source. As part of writing, write circuit 110 may process vertex attribute data as a block of k vertices, where k is an integer of two or more. For example, k may be set equal to 2, 4, 8, 16, 32, or the like. Write circuit 110 may select a plurality of vertices, e.g., k vertices, of vertex attribute data, form groups of components according to component type, and form packets of an encoded type or a generic type on a per group basis. Whether a packet is formed as an encoded packet or a generic packet (i.e., not encoded) may be determined according to a data type of the components of each respective group. Further, in the case of encoded packets, the type of encoding used may be determined according to a data type of the components of each respective group. Write circuit 110 may compress the vertex attribute data and write the compressed vertex attribute data within memory 125.

Read circuit 115 may fetch compressed vertex attribute data from memory 125. Read circuit 115 may decompress vertex attribute data, e.g., a block and/or a portion thereof, fetched from memory 125. Read circuit 115 further may determine whether the packet is encoded and selectively decode the packet according to the determination. The particular type of decoding performed by read circuit 115 for encoded packets may be determined according to data type of the components in the packet. Read circuit 115 may store the resulting decompressed vertex attribute data, or a portion thereof, within memory 120. Read circuit 115 may store the resulting decompressed vertex attribute data within memory 120 for use or consumption by another system such as a graphics system.

In one example, memory 120 may be implemented as a level 2 cache, while memory 125 is implemented as a random access memory (RAM). In that case, for example, memory 120 may be coupled to a level 1 cache. The level 1 cache may be included within a processor while memory 120 may be implemented separately from such a processor. The processor may be configured to operate upon geometric graphics data and, more particularly, vertex attribute data. In one exemplary implementation, the level 1 cache may be included within a GPU or the like, while memory 120 is external to the GPU. Memory 125 may be implemented as any of a variety of known memory element types. Exemplary RAM implementations of memory 125 may include, but are not limited to, static RAM (SRAM), dynamic RAM (DRAM), synchronous dynamic RAM (SDRAM), double data rate synchronous RAM (DDR SDRAM), or the like.

System 105 may be implemented as various circuit components and/or ICs coupled to a printed circuit board or other electrical platform. For example, system 105 may be implemented within, or as part of, a graphics processing card or the like. System 105 may be incorporated within a larger data processing system such as a computer, a gaming system, or the like. In another exemplary implementation, system 105 may be incorporated within a processor. For example, a GPU may include system 105 therein to facilitate more efficient processing of vertex attribute data.

FIG. 2 is a block diagram illustrating an exemplary implementation of write circuit 110 of FIG. 1. In the example of FIG. 2, write circuit 110 includes a block creation circuit 202 and an output stage 218. Block creation circuit 202 may include a controller 205, a block encoder 210, a packet encoder 215, and a local packet buffer 230. Output stage 218 may include an output buffer 220 and a compressor 225.

Controller 205 may be configured to receive a write request via signal 235. The write request may specify vertex attribute data to be written to memory 125. Responsive to the write request, controller 205 may instruct block encoder 210 to create a block of vertices via signal 240. For example, controller 205 may instruct block encoder 210 to generate a block of k vertices. As discussed, k is an integer value of at least two. The value of k may also be specified as vertex i through vertex j of vertex attribute data stored in memory 120 in decompressed form. As such, the instruction to create a block indicates which vertices are to be included in the block to be created. Responsive to the block creation instruction, block encoder 210 may request the attribute layout for the vertex attribute data via signal 245. More particularly, block encoder 210 may request the vertex attribute layout for the particular vertices to be included within the block. Block encoder 210 may receive the vertex attribute layout via signal 245. The vertex attribute layout, for example, may specify the particular components, e.g., none, one, or more, and component types that exist for each set of vertices to be included within the block.

Using the vertex attribute layout, block encoder 210 may determine the particular components that will be included in the vertex attribute data for each of vertices i through j. Block encoder 210 may determine the number of generic packets to be included in the block and the number of encoded packets to be included in the block for vertices i through j. Block encoder 210 may instruct packet encoder 215 to create packets for vertices i through j through signal 250.

In one aspect, the generic packets may be formed to include components of one or more particular data types not associated with an encoding technique. In one exemplary implementation, generic packets may be formed on a per component type basis for those components determined to be of a data type not associated with an encoding technique. A data type that is not associated with an encoding technique may be referred to as a generic packet data type. Encoded packets may be formed of components of vertex attribute data of a data type that is associated with a particular encoding technique. In one exemplary implementation, encoded packets may be formed on a per component type basis for those components determined to be of a data type associated with an encoding technique. A data type associated with an encoding technique may be referred to as an encoded data type.

Packet encoder 215, through signal 255, may request the vertex attribute data for vertices i through j from memory 120 and, in response, may receive the requested vertex attribute data. Packet encoder 215, responsive to receiving the vertex attribute data for vertices i through j, may generate one or more packets that are provided to local packet buffer 230 through signal 260. Packet encoder 215 may generate packets where each packet includes one type of component. Further packet encoder 215 may generate packets where the packet type, e.g., encoded or generic, is determined according to data type of the components. Packets, e.g., encoded and/or generic, may accumulate within local packet buffer 230 until the block is complete. Packet encoder 215 may notify block encoder 210 that packet(s) of the block are ready within local packet buffer 230 for compression.

Compressor 225 may receive the block, via signal 265, from local packet buffer 230. Block encoder 210 may indicate to compressor 225 to begin compression of the block via signal 270. Compressor 225, for example, may be implemented as a streaming compressor. As such, packet encoder 215 may be configured to notify block encoder 210 that a packet is ready to be compressed. Block encoder 210, in response to the notification from packet encoder 215, may notify compressor 225 to begin compression via signal 270. Packets may be encoded in sequence to maintain packet position within the resulting compressed data.

Compressor 225, responsive to signal 270, may compress the block and write the compressed block via signal 285 to memory 125. Compressor 225 further may generate metadata that is provided to output buffer 220 via signal 275. Compressor 225 further may provide a dictionary that is used for the compression of the block to output buffer 220. Compressor 225 may indicate that compression is complete to output buffer 220 through signal 280.

Responsive to the indication that compression is complete, e.g., from signal 280, output buffer 220 may write the metadata and the dictionary to memory 125 via signal 290. In one aspect, output buffer 220 may write the metadata to a first region of memory 125 and the dictionary to a second and different region of memory 125. The regions, or locations, of memory 125 in which the metadata and dictionary are stored may be known a priori to system 105, e.g., are programmed.

In one aspect, the metadata may include an index array. The index array, for example, may map the block and packets therein to a memory location where the block is stored within memory 125. The index array may include an n bit descriptor denoting a multiple of a number of m bytes that are loaded to get the compressed block. For example, using a cache line size wherein m is 64 bytes, the size may be determined according to size=m*2^{desc}=64*2^{desc}, where “desc” is the number of descriptors used.

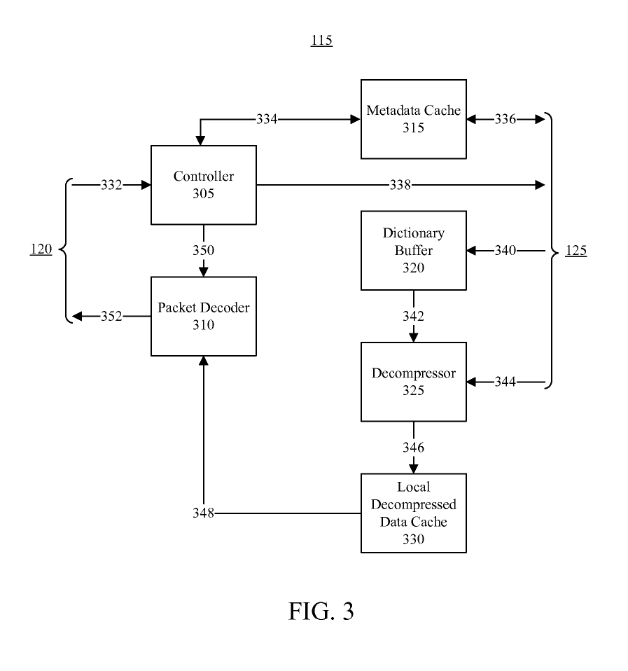

FIG. 3 is a block diagram illustrating an exemplary implementation of read circuit 115 of FIG. 1. In the example of FIG. 3, read circuit 115 includes a controller 305, a packet decoder 310, a metadata cache 315, a dictionary buffer 320, a decompressor 325, and a local decompressed data cache 330.

Dictionary buffer 320 may receive, e.g., fetch, a dictionary from memory 125 via signal 340. The received dictionary is used to decompress compressed blocks fetched from memory 125. It should be appreciated that the dictionary need only be fetched one time for a frame and/or image. For example, the dictionary may be loaded once and kept in dictionary buffer 320 for the duration of a decompression process for one rendered image of a GPU.

Controller 305 may be configured to receive read requests via signal 332. Responsive to a read request, controller 305 may be configured to query metadata cache 315 via signal 334 to determine whether metadata cache 315 includes the portion of metadata needed to translate an address, e.g., a first address, specified by the read request into a second address within memory 125 specifying compressed data.

Metadata may need to be fetched multiple times depending on the size of metadata cache 315. The addressing used within the metadata may be linear. The size of an entry, for example, may be constant and may include a base address and a size of blocks specified as a number of cache lines. In another aspect, the base address may be known a priori, in which case the metadata may only specify size. Each compressed block, for example, may begin at an address determined as (known base address)+(block ID*size of the uncompressed block). The address of the metadata for a block may be specified as a metadata base address plus the block ID*the size of a metadata row. Metadata cache 315 knows whether the requested address exists therein, i.e., is stored locally within metadata cache 315, or not. If so, metadata cache 315 provides the metadata for the requested address to controller 305 via signal 334. If not, metadata cache 315 may send a metadata request to memory 125 via signal 336.

In response to the metadata request, metadata cache 315 may receive a metadata response also via signal 336. Metadata cache 315 may provide the received metadata, e.g., the index array, to controller 305 via signal 334. Using the received metadata, controller 305 may translate the first address specified in the received read request to a second address where the compressed block is stored in memory 125. Controller 305 may be configured to send a read request to memory 125 via signal 338. The read request from controller 305 to memory 125 may specify the second address indicating a particular compressed block to be fetched.

The metadata may include one line of data per compressed block. Referring to FIG. 2, for example, each block may be stored by compressor 225 in a memory region having a size that is a multiple of the cache line size of m referring to the example above. Data may be fetched from memory 125, e.g., a RAM, as one or more cache lines. The number of cache lines that a block may require for storage in the worst case is the uncompressed size of the block. The number of cache lines may be expressed using the “desc” bits. In general, the size of a compressed block may be expressed using the “desc” bits, which are added to the metadata.

For example, if the request is received for vertex i, attribute j, a metadata lookup may be performed. The block ID needed may be expressed as i/<#vertices per block>. The block ID may serve as the row to be accessed in the index array of the metadata. From the index array, the base address in memory 125 from which to read the requested compressed block may be determined. Using the “desc” bits, the number of cache lines to request may be determined. The retrieved cache lines, i.e., the requested block, may be provided to decompressor 325 in a serial order, e.g., via signal 344.

Dictionary buffer 320 may provide the dictionary to decompressor 325 through signal 342. As noted, decompressor 325 may receive the compressed block requested by controller 305 from memory 125 through signal 344. Decompressor 325 may decompress the compressed block using the dictionary provided from dictionary buffer 320. Decompressor 325 may output decompressed packets via signal 346 to local decompressed data cache 330. Local decompressed data cache 330 may provide the decompressed block, i.e., the block, to packet decoder 310 through signal 348.

Packet decoder 310 may receive metadata from controller 305 through signal 350. In one aspect, packet decoder 310 may determine whether packets require decoding and the particular decoding to be performed, if at all, from the received metadata. The metadata may be used by packet decoder 310 to decode packets, if needed, of the block received from local decompressed data cache 330. Packet decoder 310 may selectively decode packet(s) of the block using the metadata and output the decompressed vertex attribute data to memory 120 through signal 352.

As noted, for example, packet decoder 310 may determine, from the metadata, whether a packet is generic or encoded. Further, in another aspect, packet decoder 310 may determine, from the metadata, a particular output format in which the vertex attribute data should be written. For example, the vertex attribute data may be expected in an array-of-structs order where attributes are ordered according to x, y, z, w, x, y, z, w, etc. for components instead of x, x, x, y, y, y, z, z, z, w, w, w. If such a transformation is required, packet decoder 310 may perform the transformation.

In still another aspect, packet decoder 310 may provide an offset of the desired data via signal 352. Using the offset, the requesting system may index into the uncompressed block to locate the data that was initially requested.

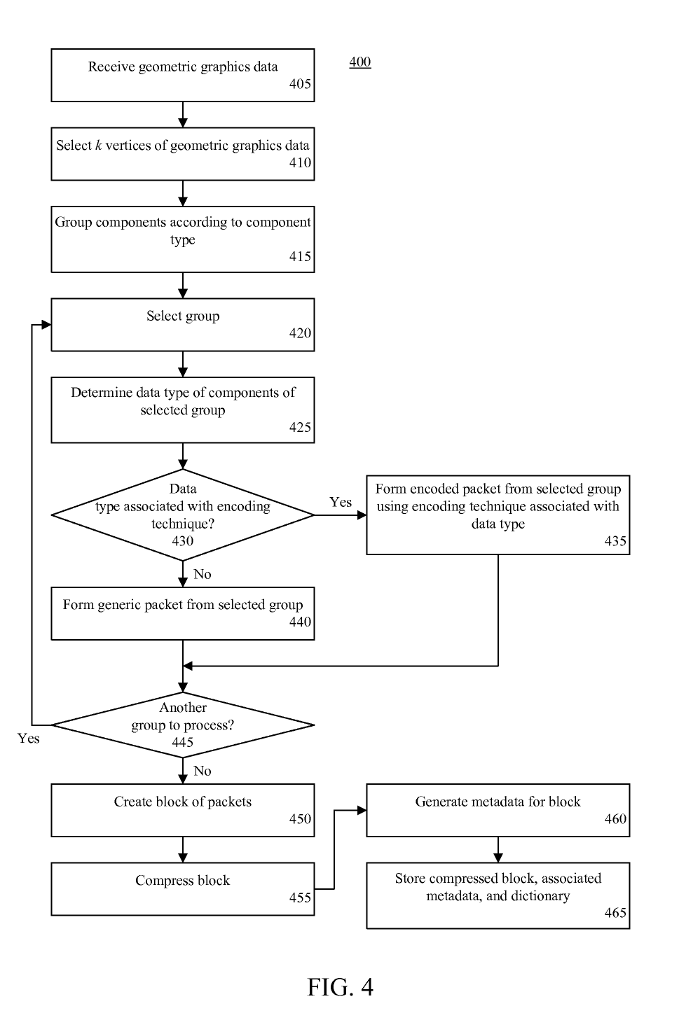

FIG. 4 is a flow chart illustrating an exemplary method 400 of writing geometric graphics data. More particularly, method 400 is directed to writing vertex attribute data. Method 400 may be performed by system 105 of FIG. 1. For example, method 400 may be performed by write circuit 110 as described with reference to FIGS. 1 and 2 of this disclosure.

In block 405, the system may receive geometric graphics data. For example, the system receives vertex attribute data. The system may receive vertex attribute data specifying a plurality of vertices for one or more polygons that are to be written to memory. The polygons may be for a particular mesh representing an object or for a plurality of meshes representing a plurality of objects.

In block 410, the system may select k vertices of the geometric graphics data to be included within a same block. For example, the system may select the components of the vertex attribute data for k different vertices. As noted, components of vertex attribute data are scalar values, e.g., scalar components. The system may determine which vertices i through j are to be included within a block. The block encoder, for example, may determine the vertices to be included in the block.

In block 415, the system may group the components of the k vertices according to component type. For example, if the components include x-coordinates, y-coordinates, and z-coordinates, a group of x-coordinates may be formed, a group of y-coordinates may be formed, and a group of z-coordinates may be formed. If the components also include red values, green values, and blue values, a group of red values may be formed, a group of green values may be formed, and a group of blue values may be formed.

In illustration, consider vertex attribute data for a mesh of two polygons where the polygons are triangles. The coordinates of the vertices in (x₁, y₁, z₁) form are (0, 0, 99), (0, 1, 99), (1, 0, 99), and (1, 1, 99). For purposes of illustration, the coordinates, i.e., the components, are specified in base 10 as opposed to binary format. The components may be grouped in [x₁ x₂ X₃ x₄ y₁ y₂ y₃ y₄ z₁, z₂, z₃, z₄] form, where each group includes one particular component type. Accordingly, the components are grouped into three groups with a first group including four x-coordinate components, followed by a second group including four y-coordinate components, followed by a third group including four z-coordinate components as [0 1 1 0 0 0 1 1 99 99 99 99].

In block 420, the system may select a group for processing. In general, each group will be used to generate a packet. In this regard, the system may form packets on a per-group basis. The system may form one packet for each group of components.

In block 425, the system may determine the data type of components in the selected group. In general, the system may distinguish between components of the selected vertices according to data type. The system may determine data type of components at any of a variety of different stages or times. For example, the system may distinguish components according to data type prior to grouping, after grouping as illustrated in FIG. 4, or at other locations within the flow chart. The particular example of FIG. 4 is provided for purposes of illustration only and is not intended as a limitation of the inventive arrangements described herein.

In block 430, the system may determine whether the data type of the components in the selected group is associated with an encoding technique. If so, method 400 may continue to block 435. If not, method 400 may proceed to block 440. For example, the system may determine whether the data type of the components of the selected group is an encoded data type or a generic data type.

In one example, the system may store associations of data types with encoding techniques (and, as such, decoding techniques). This allows the system to selectively encode packets according to data type of the components in the group. In cases where a packet is to be formed as an encoded packet, the particular type of encoding also may be determined and/or selected according to the data type of components in the selected group.

For purposes of illustration, a group including components having a first data type may be formed into an encoded packet. The encoded packet may be encoded using a first encoding technique associate with the first data type. A group including components of a second and different data type may formed into an encoded packet using a second and different encoding technique associated with the second data type.

For example, a group of floating point components may be formed into an encoded packet using an encoding technique reserved for floating point components. A group of integer components may be formed into an encoded packet using an encoding technique reserved for integer components. Any group having components with a data type not associated with an encoding technique, e.g., a generic data type, may be included in a generic packet. In another aspect, the number of vertices included in encoded packets and, therefore, in a block, may depend upon the compression ratio desired and an over fetch rate in the cache.

In block 435, the system may form an encoded packet from the selected group. The system may form the encoded packet using an encoding technique that is associated with the data type of the components of the selected group. For example, the packet encoder may form the encoded packet. After block 435, method 400 may continue to block 445.

In block 440, the system may form a generic packet from the selected group. For example the packet encoder may form the generic packet. Generic packets may not be sorted or otherwise processed as are encoded packets. The system, for example, may copy each component of the group to a continuous region of memory to form the generic packet.

In some cases, the system may perform one or more operations on the generic packets. For example, the system may perform delta operations, as described herein in greater detail, on generic packets. Performing delta operations on generic packets may improve the compression ratios that are achieved. An example of a delta operation includes performing a bitwise XOR operation of bits from adjacent scalar values, e.g., from adjacent components.

In block 445, the system may determine whether another group remains to be processed. If so, method 400 may loop back to block 420 to select a next group for processing. If not, method 400 may continue to block 450. Accordingly, the number of generic and encoded packets will depend upon the data type of components in the various groups. The data type of components may be determined for the selected vertices from the vertex attribute layout.

In block 450, the system, e.g., the packet encoder, may create a block of packets. The block of packets includes any encoded packets generated in block 435 and any generic packets generated in block 440. For example, the system may write the encoded packets and the generic packets to a local memory within the system forming the block. In one aspect, the packets of the block may be stored adjacent to one another, e.g., sequentially. In another aspect, the packets of the block may be stored in an interleaved format. It should be appreciated that the block may be formed of all encoded packets, all generic packets, or a mix of encoded and generic packets according to the particular data types of the components in the groups that are processed.

In block 455, the system, e.g., the compressor, may compress the block. The compressed block includes vertex attribute data for the selected vertices, i.e., the k vertices referenced as vertex i through vertex j. The system may compress the block using any of a variety of known compression techniques. In one aspect, the system may compress the block using a streaming type of compression technique. For example, the system may utilize a streaming compression technique that works in at most two passes. The first pass may be used to determine the most efficient way to compress the block, while the second pass is used to actually perform compression.

In one example, Huffman coding may be used as the compression technique. Huffman coding may be performed, for example, by compressor 225 of write circuit 110. The compressor may use an eight bit alphabet and use a 256 entry dictionary. The Huffman encoder may operate using a single pass approach or a double pass approach. In the single pass approach, a pre-defined dictionary is used to encode the block. In the two-pass approach, the first pass generates a histogram of data. During the second pass, the histogram is used to define the Huffman codes.

In another example, a Lempel-Ziv (LZ) class compression technique may be used. As known, LZ class compression uses Huffman coding to write data to memory with a pre-defined Huffman tree or custom Huffman tree depending on the number of passes desired. For instance, an LZ77 compressor may be used with 8 bit data, pointers, and 4 bit lengths. Since the LZ77 compression works by replacing portions of data with backward references, a 1 bit descriptor may be used before each entry to determine whether the entry is data represented by a zero or a backward reference represented by a 1. Data may be written as an 8 bit entry. Backward references may use an 8 bit pointer with a 4 bit length entry. Because block level access to data is to be preserved, backward references may be restricted to the block dimensions. In other examples, Lempel-Ziv-Welch (LZW) compression may be used. LZW compression may be applied using a two-pass approach using a 256 entry dictionary similar to the Huffman coding discussed above.

The various examples of compression techniques provided herein are for purposes of illustration only. The inventive arrangements are not intended to be limited to one particular type and/or technique of compression or to the examples provided.

In block 460, the system may generate metadata for the block. The compressor, for example, may generate the metadata. In one aspect, the metadata may include an index array. The index array, for example, may map the block and packets therein to a memory location where the block will be stored. The memory location where the block will be stored further may be associated with a block identifier or address that is used by the system providing the data to be written or the requesting system in the case where a block is being fetched. The index array further may include an n bit descriptor denoting a multiple of 64 bytes that are loaded to get the compressed packet. For example, using a cache line size of 64 bytes, the size=64*2^{dsec}.

In block 465, the system may store the compressed block, the metadata for the block, i.e., the metadata generated in block 460, and the dictionary within memory. Referring to the example of FIGS. 1 and 2, for example, system may store the compressed block, the metadata for the block, and the dictionary within memory 125, e.g., a RAM.

Method 400 illustrates the operations performed to write multiple vertices as a single block. It should be appreciated that method 400 may be performed multiple times to write vertex attribute data to memory as a plurality of blocks. For example, in the case where the geometric graphics data received in block 405 is to be written to memory as more than one block, method 400, e.g., blocks 410-465, may be performed one time for each block that is to be generated.

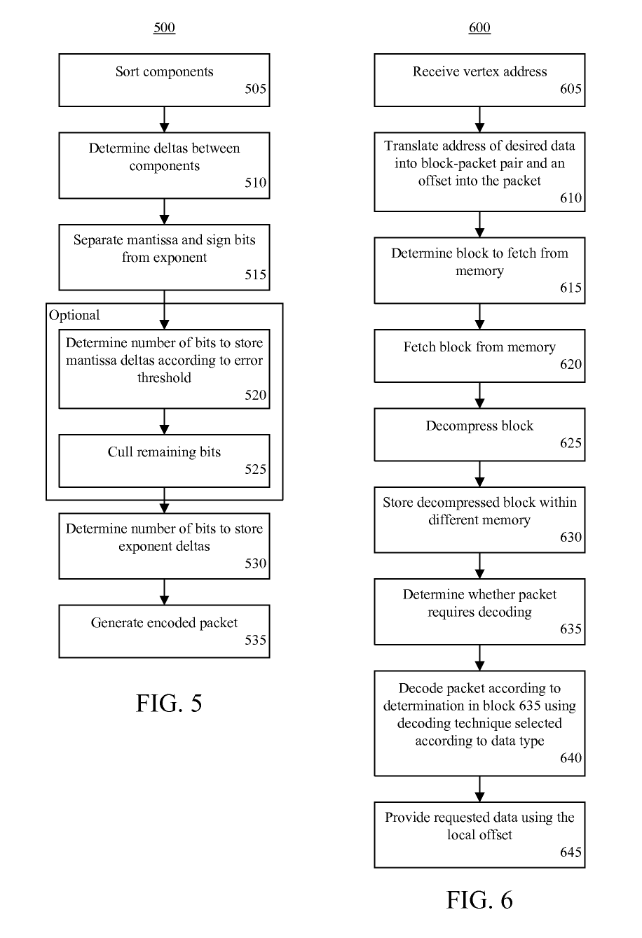

FIG. 5 is a flow chart illustrating an exemplary method 500 of encoding a packet. Method 500 illustrates an exemplary encoding technique that may be used for groups of components have a data type of floating point. In this regard, method 500 may be used to implement block 435 of FIG. 4. For purposes of illustration, the components, which are of floating point type in this example, are coordinates. It should be appreciated, that any group including components of floating point data type of various precisions may be processed and included within an encoded packet using the encoding process described with reference to FIG. 5 or one similar thereto.

A floating point representation of a number is an exponential representation where the effect of lower-order bits is significantly lower than the effect of higher-order bits. Geometric data, e.g., vertex attribute data, has a high degree of similarity, particularly when considered as scalars of a same component type as opposed to vector form. Vertex attribute data typically is bounded in range and exhibits locality due to mesh reordering within graphics systems. Accordingly, within floating point components, the exponent bits typically exhibit a high-degree of similarity. Deltas, i.e., the difference between successive numbers, are likely small.

In block 505, the system may sort the components within the group, e.g., the selected group of FIG. 4. In one aspect, the components within the selected group may be sorted, or re-ordered, in ascending order. For example, referring to the prior example of coordinates of FIG. 4, the x-coordinates originally ordered as [0 1 1 0] may be sorted in ascending order resulting in the following [0 0 1 1] sort order. Sorting the components of a group in ascending, or at least in a non-descending, order ensures that the deltas will be positive. A record of the original order of the components in the selected group may be maintained in order to place the respective components in their original order, e.g., the presort order, for purposes of decoding.

In block 510, the system may determine deltas for the group. A delta is the difference between two successive components. In the example of FIG. 5, the delta is between two successive components in a group once sorted. For example, the system may select the first component in the sorted group of x-coordinates. Referring to the prior example, the first x-coordinate component is 0. The first x-coordinate component in the sorted group is used as the first value, i.e., 0. Since the second x-coordinate component is also 0, the delta between the first x-coordinate component and the second x-coordinate component in the group of sorted x-coordinate components is 0 resulting in [0 0]. The third x-coordinate component is 1, meaning there is a delta of 1 between the second x-coordinate component and the third x-coordinate component in the sorted group of x-coordinate components resulting in [0 0 1]. The delta between the third and the fourth x-coordinate components in the group of sorted x-coordinates is 0, resulting in [0 0 1 0]. The delta operations described with reference to block 510 may also be performed on a generic packet as previously noted.

In block 515, the system separates the mantissa and sign bits from the exponent for each delta of the components. For example, the components may be specified as 32-bit single-precision floating point numbers. The mantissa may be 24 bits, while the exponent may be 8 bits.

Blocks 520 and 525 may be optionally performed. In one aspect, blocks 520 and 525 may be performed when a larger amount of compression is desired. In that case, the system may apply lossy compression. In another aspect, for example, where lossless compression is desired, blocks 520 and 525 may be omitted or bypassed.

In the case where lossy compression is applied, the user may specify an error threshold. Based upon a specified error threshold, which may be a user-specified error threshold, the system may determine the maximum number of mantissa bits required for representing a delta in block 520. In block 525, the system may cull, or remove, the bits beyond the determined maximum number of mantissa bits needed to meet the error threshold. The number of bits used in a packet to store mantissa deltas may be specified as part of the packet header. The number of bits used to store mantissa deltas may be similar to the number of bits used to encode exponent deltas, though the values may be encoded differently. For exponent deltas, for example, values of 1, 2, 4, and 8 may only be permitted for efficiency. For mantissa deltas, any value between 0 and 24 may be used in the case of single precision floating point values.

In another aspect, error thresholds may be specified on a per component type basis (i.e., on a per encoded packet basis). Thus, one error threshold may be specified for one or more component types while another different error threshold may be specified for one or more other component types. Further error thresholds, e.g., third, fourth, etc., may also be specified. As an illustrative example, a first error threshold may be specified for x-coordinates, y-coordinates, and z-coordinates. A second and different error threshold may be specified for RGB values. In a further example, one error threshold may be specified for x-coordinates, another error threshold for y-coordinates, and yet another error threshold for z-coordinates. In this regard, each encoded packet may have its own error threshold. The error threshold may be the same as one or more other encoded packets, different from one or more other encoded packets, or unique among the encoded packets.

In another exemplary implementation, blocks 520 and 525 may be performed regardless of whether lossy compression is to be applied. For example, in the case where the error threshold is non-zero, blocks 520 and 525 may be performed as discussed. In another example, where lossy compression is not to be applied, the error threshold may be specified as zero. In the case of a zero error threshold, blocks 520 and 525 may be performed, but the mantissa may be maintained at the full number of bits, e.g., 24 bits, with no bits being culled.

The following discussion illustrates one technique for determining the number of mantissa bits to be culled to achieve a given error threshold. For purposes of illustration, a 32 bit floating point number is assumed where, moving from right to left, bits 0-22 are mantissa bits, bits 23-30 are exponent bits, and bit 31 is a sign bit. It should be appreciated that while a 32 bit floating point number is used in the example, the technique described may be scaled or extended to process other floating point bit widths.

Any 32 bit floating point number may be represented as:

$$value = {( - 1 )}^{sign} ( 1 + {\sum }_{i = 1}^{23} {mantissa}_{23 - i} {2}^{- i} ) \times {2}^{exponent - 127}$$

If k bits are culled starting from the Least-Significant Bit (LSB), the absolute error in magnitude is then:

$$error = ( {\sum }_{i = 23 - k}^{23} {mantissa}_{23 - i} {2}^{- i} ) \times {2}^{exponent - 127}$$

The maximum possible error can be bounded by assuming each mantissa bit is 1, and the exponent is the maximum exponent within a packet:

$$error = ( {\sum }_{i = 23 - k}^{23} {2}^{- i} ) \times {2}^{{max}_{exponent} - 127}$$

The above expression may be rewritten using formulas for the sum of a geometric series as shown below where £ represents the user-specified error threshold:

$$error = {2}^{- 23 + k} \times \frac{1 - {2}^{- k - 1}}{1 - \frac{1}{2}} \times {2}^{{max}_{exponent} - 127} \leq ɛ$$

Since 1−2^{-k-1}<1, the expression above may be replaced with 1 to obtain a conservative approximation for k:

error==2^{-22+k}×2^{max}^{ₑₓₚₒₙₑₙₜ}⁻¹²⁷≦ε

After taking the log of both sides, the expression above may be rewritten as shown below:

k≦log₂ε+22−(maxₑₓₚₒₙₑₙₜ−127)

In the above example, the notation (maxₑₓₚₒₙₑₙₜ−127) is used since exponents stored with a bias of 127 in the IEEE floating point convention are to be corrected. In one aspect, though all 23 mantissa bits may be culled, a minimum of 1 mantissa bit may be maintained to differentiate error values.

In block 535, the system determines the number of bits needed to store the exponent deltas of the floating point components. In block 540, the system generates encoded packets. The system may generate, e.g., write, an encoded packet for each of the groups. For example, for floating point 32 bit (FP32) data, the encoded packet may include a header portion and a data portion.

For example, the header of an encoded packet may include:
2 bit code for number of bits per exponent delta. The code may map to 1, 2, 4, or 8.
5 bits for the number of mantissa bits or a 3 bit code.
8 bits for the base exponent.
Sorting order bits specifying the presort order to undo the sorting for the groups.

The data portion of an encoded packet may include, for example:
Mantissa bits specifying deltas for k numbers.
Exponent bits specifying deltas for k numbers.

FIG. 5 is provided as one example of an encoding technique. Other encoding techniques may be used for other data types. For example, in the case of a group of components specified as 8-bit unsigned integers as the data type, the encoding may include sorting values in non-ascending order, taking deltas, and determining the minimum bits needed for full accuracy, and culling the unneeded bits. In one aspect, the minimum number of bits needed may be 3 bits. The number of bits used to keep full accuracy and the original order may be stored as part of the encoded packet. Lossy compression may be used if desired using the error thresholds as previously discussed.

In another example, a different encoding technique may be used for a group of components of a fixed point decimal data type. In that case, the encoding may include sorting components in non-descending order, separating integer and decimal portions, and determining deltas for the integer and decimal portions separately. The encoding further may include determining the minimum number of bits needed for accuracy for the integer delta and the decimal delta portions separately, and culling the unneeded bits from each respective portion. In one aspect, the number of bits needed for the integer delta and the decimal delta each may be 3 bits. Lossy compression may be used if desired using the error thresholds as previously discussed.

The examples provided within this disclosure are not intended to be limiting. Other encoding techniques may be used for the various data types described herein and/or for other data types not specifically discussed. Further, in some cases, groups including components of those data types that are described herein as being associated with an encoding technique may instead be used to form generic packets.

FIG. 6 is a flow chart illustrating an exemplary method 600 of reading geometric graphics data. More particularly, method 600 is directed to reading vertex attribute data. Method 600 may be performed by system 105 of FIG. 1. For example, method 600 may be performed by read circuit 115 described with reference to FIGS. 1 and 3.

In block 605, the system receives an address. In one aspect, the address may be a vertex identifier. In block 610, the system translates the address of the desired data into a block/packet pair and an offset into the packet. In one aspect, the system may perform the translation using the metadata. For example, the system may determine the block/packet pair and offset from the address using the index array.

In block 615, the system may determine the particular block to fetch from memory using the metadata. For example, the system may determine the particular address within the memory where the block determined in block 610 is located. In block 620, the system may retrieve, or fetch, the block using the address determined in block 615. The block, as stored in memory, is in compressed form. Accordingly, in block 625, the system may decompress the retrieved block. The system may decompress the retrieved block using the appropriate dictionary, which also may be retrieved from the memory with the compressed block.

In block 630, the system may store the decompressed block within a different memory. For example, the system may store the decompressed block within a cache memory such as a level 2 cache memory. In block 635, the system may determine whether the packet requires decoding. For example, the system may determine whether the packet is decoded or generic. The system may make the determination from the metadata. In block 640, the system may decode the packet of the uncompressed block according to the determination in block 635. The system may decode the packet, in the event decoding is required, using a decoding technique selected according to the data type of the components of the packet.

The decoding technique used, for example, may be one associated with the data type of components in the packet. In one aspect, the decoding technique may be the reverse of the particular operations performed when encoding the packet. For example, the system may perform a reverse delta operation for components in the packet, order the components of the packet in the original order specified within the packet (e.g., unsort the components), and group the components according to individual vertices. For example, the system may order the components in (x, y, z) format for each vertex. A reverse delta operation refers to deriving the original components from the stored first component value and subsequent stored delta(s).

In block 645, the requested data may be provided using the local offset. For example, the data beginning at the local offset of the decompressed block may be provided to a graphics system, another memory, or the like.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the term “another” means at least a second or more.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “coupled” means connected, whether directly without any intervening elements or indirectly with one or more intervening elements, unless otherwise indicated. Two elements may be coupled mechanically, electrically, or communicatively linked through a communication channel, pathway, network, or system.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” or similar language mean that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “plurality” means two or more than two.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a GPU, a digital signal processor (DSP), a field-programmable gate array (FPGA), a programmable logic array (PLA), an application specific integrated circuit (ASIC), programmable logic circuitry, and a controller.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

From time-to-time, the term “signal” may be used within this disclosure to describe physical structures such as terminals, pins, signal lines, wires, and/or the corresponding signals propagated through the physical structures. The term “signal” may represent one or more signals such as the conveyance of a single bit through a single wire or the conveyance of multiple parallel bits through multiple parallel wires. Further, each signal may represent bi-directional communication between two, or more, components connected by the signal.

The terms first, second, etc. may be used herein to describe various elements. These elements should not be limited by these terms, as these terms are only used to distinguish one element from another unless stated otherwise or the context clearly indicates otherwise.

The flowchart and block diagrams in the Figures illustrate the architecture, functionality, and operation of possible implementations of systems and methods according to various aspects of the inventive arrangements disclosed herein.

In one aspect, the blocks in the flow chart illustration may be performed in the order indicated. In other aspects, the blocks may be performed in an order that is different, or that varies, from the numerals in the blocks, the order described, and/or the order shown. For example, two or more blocks shown in succession may be executed substantially concurrently. In other cases, two or more blocks may sometimes be executed in the reverse order, depending upon the functionality involved. In still other cases, one or more blocks may be performed in varying order with the results being stored and utilized in other blocks that do not immediately follow.

The corresponding structures, materials, acts, and equivalents of all means or step plus function elements in the claims below are intended to include any structure, material, or act for performing the function in combination with other claimed elements as specifically claimed.

A method may include selecting a plurality of vertices of vertex attribute data, forming groups of components of the plurality of vertices according to component type, and forming packets of an encoded type or a generic type on a per group basis according to a data type of the components of each respective group.

The method may include compressing a block including the packets.

Forming packets may include determining a data type of the components of a group and determining an encoding technique used to encode the packet according to the data type.

Forming packets may include encoding a packet including components of a first data type using a first encoding technique associated with the first data type. Forming packets may include encoding a packet including components of a second and different data type using a second encoding technique associated with the second data type, where the second encoding technique is different from the first encoding technique. In other cases, forming packets may also include forming a generic packet for a group including components of a second and different data type.

Forming packets of the encoded type may include sorting the components, storing, as part of the packet, an original order of the components, and determining a delta between the components.

The method may include determining a number of bits to store at least a portion of deltas according to an error threshold and cull unneeded bits. In one aspect, the error threshold may be selected according to component type.

The method also may include generating metadata including an index array for the compressed block and storing the metadata in a memory.

A method may include determining a block, a packet within the block, and a local offset into the packet from a first address specifying requested vertex attribute data, and fetching the block from a memory. The block includes the packet. The method may include decompressing the block, determining whether the packet is encoded and selectively decoding the packet according to the determination, and providing at least a portion of the packet indicated by the local offset.

The method may include determining a second address specifying a location of the block within the memory using the metadata. The block may be fetched from the memory using the second address.

Decoding the packet may include performing a decoding technique selected according to a data type of components of the packet.

A system may include a write circuit configured to form groups of components of the plurality of vertices according to component type and form packets of an encoded type or a generic type on a per group basis according to a data type of the components of each respective group.

The write circuit may include a packet encoder configured to group components of the vertex attribute data according to component type.

The packet encoder may be configured to distinguish between components of vertex attribute data according to data type.

The packet encoder may be configured to determine a data type of the components of a group and determine an encoding technique used to encode the group as an encoded packet according to the data type.

The packet encoder may be configured to form packets of the encoded type by sorting the components, storing, as part of the packet, an original order of the components, and determining deltas between the components.

The packet encoder may be configured to determine a number of bits to store at least a portion of deltas according to an error threshold and cull unneeded bits. In one aspect, the error threshold may be selected and/or determined according to component type.

The packet encoder may be configured to generate encoded packets including components of a first data type and generate generic packets including components of a second and different data type.

The write circuit may include a compressor coupled to the packet encoder and configured to compress a block including the packets, generate metadata mapping memory locations to the block and packets within the block, and store the compressed block within the memory at a location indicated by the metadata.

The system may include a read circuit configured to fetch the compressed block from memory, decompress the compressed block fetched from the memory, and selectively decode a packet of the block according to whether the packet is encoded.

The read circuit may include a controller configured to receive a read request for vertex attribute data, determine the compressed block, the packet of the block, and an offset into the packet from the request, and fetch the compressed block from a memory.

The read circuit may include a decompressor configured to decompress the compressed block and a packet decoder coupled to the decompressor and the controller. The packet decoder may be configured to selectively decode the packet. For example, responsive to determining that the packet is an encoded packet, the packet decoder may be configured to perform a decoding technique selected according to a data type of components of the encoded packet.

The features described within this disclosure may be embodied in other forms without departing from the spirit or essential attributes thereof. Accordingly, reference should be made to the following claims, rather than to the foregoing disclosure, as indicating the scope of such features and implementations.

What is claimed is:

1. A method, comprising:
selecting a plurality of vertices of vertex attribute data;
forming groups of components of the plurality of vertices according to component type; and
forming packets of an encoded type or a generic type on a per group basis according to a data type of the components of each respective group.

2. The method of claim 1, further comprising:
compressing a block comprising the packets.

3. The method of claim 1, wherein forming packets further comprises:
determining a data type of the components of a group; and
determining an encoding technique used to encode the packet according to the data type.

4. The method of claim 1, wherein forming packets further comprises:
encoding a packet comprising components of a first data type using a first encoding technique associated with the first data type.

5. The method of claim 4, further comprising:
encoding a packet comprising components of a second and different data type using a second encoding technique associated with the second data type, wherein the second encoding technique is different from the first encoding technique.

6. The method of claim 4, further comprising:
forming a generic packet for a group comprising components of a second and different data type.

7. The method of claim 1, wherein forming packets of the encoded type comprises, for a selected group:
sorting the components;
storing, as part of the packet, an original order of the components; and
determining a delta between the components.

8. The method of claim 7, further comprising:
determining a number of bits to store at least a portion of deltas according to an error threshold and cull unneeded bits.

9. The method of claim 8, wherein the error threshold is selected according to component type.

10. The method of claim 1, further comprising:
generating metadata comprising an index array for the compressed block; and
storing the metadata in a memory.

11. A method, comprising:
determining a block, a packet within the block, and a local offset into the packet from a first address specifying requested vertex attribute data;
fetching the block from a memory, wherein the block comprises the packet;
decompressing the block;
determining whether the packet is encoded and selectively decoding the packet according to the determination; and
providing at least a portion of the packet indicated by the local offset.

12. The method of claim 11, further comprising:
determining a second address specifying a location of the block within the memory using the metadata;
wherein the block is fetched from the memory using the second address.

13. The method of claim 11, wherein decoding the packet comprises performing a decoding technique selected according to a data type of components of the packet.

14. A system, comprising:
a write circuit configured to form groups of components of the plurality of vertices according to component type and form packets of an encoded type or a generic type on a per group basis according to a data type of the components of each respective group.

15. The system of claim 14, wherein the write circuit comprises:
a packet encoder configured to group components of the vertex attribute data according to component type.

16. The system of claim 15, wherein the packet encoder is configured to distinguish between components of vertex attribute data according to data type.

17. The system of claim 15, wherein the packet encoder is configured to determine a data type of the components of a group and determine an encoding technique used to encode the group as an encoded packet according to the data type.

18. The system of claim 15, wherein the packet encoder is configured to form packets of the encoded type by sorting the components, storing, as part of the packet, an original order of the components, and determining deltas between the components.

19. The system of claim 18, wherein the packet encoder is configured to determine a number of bits to store at least a portion of deltas according to an error threshold and cull unneeded bits.

20. The system of claim 19, wherein the error threshold is selected according to component type.

21. The system of 15, wherein the packet encoder is configured to generate encoded packets comprising components of a first data type and generate generic packets comprising components of a second and different data type.

22. The system of claim 15, wherein the write circuit comprises:
a compressor coupled to the packet encoder and configured to compress a block comprising the packets, generate metadata mapping memory locations to the block and packets within the block, and store the compressed block within the memory at a location indicated by the metadata.

23. The system of claim 14, further comprising:
a read circuit configured to fetch the compressed block from memory, decompress the compressed block fetched from the memory, and selectively decode a packet of the block according to whether the packet is encoded.

24. The system of claim 23, wherein the read circuit comprises:
a controller configured to receive a read request for vertex attribute data, determine the compressed block, the packet of the block, and an offset into the packet from the request, and fetch the compressed block from a memory.

25. The system of claim 24, wherein the read circuit comprises:
a decompressor configured to decompress the compressed block; and
a packet decoder coupled to the decompressor and the controller, wherein the packet decoder is configured to selectively decode the packet.

26. The system of claim 25, wherein, responsive to determining that the packet is an encoded packet, the packet decoder is configured to perform a decoding technique selected according to a data type of components of the encoded packet.
